(19) United States
(12) Patent Application Publication
(10) Pub. No.: US 2002/0140871 A1
(43) Pub. Date: Oct. 3, 2002

(54) Seamless control of input TV signals

(75) Inventors: Tony Piotrowski, Wayne, NJ (US); Danial J. Piotrowski, Edison, NJ (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/819,289

(22) Filed: Mar. 28, 2001

(51) Int. Cl. G06F 3/00; H04N 5/445; G06F 13/00; H04B 17/02; H04B 1/18; H04N 5/50

(52) U.S. Cl. 348/731; 455/133; 455/150.1

(57) ABSTRACT

An apparatus and method for switching a channel among a plurality of sources selected by a viewer are provided. The apparatus includes: a plurality of tuners coupled to receive incoming channel signals from the plurality of sources for decoding the received channel signals; a switch circuit coupled to receive the output signals from each of the plurality of tuners; and, a controller, coupled to the plurality of tuners and the switch circuit, for retrieving the output signals indicative of a desired program selected by the viewer according to predetermined channel map information. The method includes the steps of: receiving a plurality of television programs from the plurality of sources; retrieving one of the television programs from the plurality of sources in response to a user selection according to a predetermined channel map data; and, forwarding the retrieved television program to the television system for display.

### BACKGROUND OF THE INVENTION

1. Field of the Invention

The present invention relates to an information management system, and more particularly, to a method and apparatus for switching a channel among a plurality of sources selected by a viewer.

2. Description of Related Art

The modem world with huge amounts of multimedia content and varied delivery options gives us a tremendous variety and range of options and choices. Currently, over 500 different program channels are shown through a variety of service mediums, including satellite dishes, coax cable, telephone lines, fiber optic cable, and television broadcast.

As more channels are available to consumers from a plurality of sources, many televisions are equipped with multiple input-signal feeds, such as antenna/coaxial inputs, video signal inputs (e.g., VCR or DVD), S-video inputs, etc. In order to view different TV signals received by different input signal feeds, a viewer typically has to manually switch, via a screen menu, between multiple input signal feeds. However, in a modem society where automation and remote controls are readily available, it becomes burdensome to many consumers to manually switch between different input signal feeds. For example, most satellite dish service providers are prohibited from broadcasting local television stations. As a consequence, users are forced to connect an additional external antenna or cable input to receive the local broadcast stations, or alternatively pay more subscription fees to receive the local broadcast stations via the satellite dish. As most viewers often spend a lot of time “channel surfing,” trying to find something he or she is interested in watching, this manual switching between different input signal feeds interferes with speedy “channel surfing” and causes users to miss important or interesting information.

Accordingly, there is a need to allow a seamless transition between different channels/TV programs associated with different input signal feeds, so that the frustration associated with manually switching the hundreds of different programs can be minimized.

### SUMMARY OF THE INVENTION

In the preferred embodiment, the present invention is directed to a method and apparatus for switching a desired channel program among a plurality of different program sources.

Accordingly, the present invention provides an apparatus capable of switching a channel selected by a viewer among a plurality of sources, including: at least one tuner, coupled to receive incoming channel signals from the plurality of sources, for decoding the channel signals received from various sources; a switch circuit coupled to receive the output signals from the tuner; and, a controller, coupled to the tuner and the switch circuit, for retrieving the output signals indicative of a desired program selected by the viewer.

The present invention provides a method of providing a desired television program from a plurality of sources to a television system which includes the steps of: receiving a plurality of television programs from the plurality of sources; selecting one of the television programs from the plurality of sources in response to a user selection according to a predetermined channel map data; and, forwarding the selected television program to the television system for display.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 illustrates a simplified block diagram of the system according to an embodiment of the present invention;

FIG. 2 illustrates a channel map system according to an embodiment of the present invention;

FIG. 3 is an exemplary process flow chart for automatic switching operation between a plurality of channels according to the present invention;

FIG. 4 is a simplified block diagram of another embodiment of the present invention; and,

FIG. 5 is a simplified block diagram of another exemplary embodiment of the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

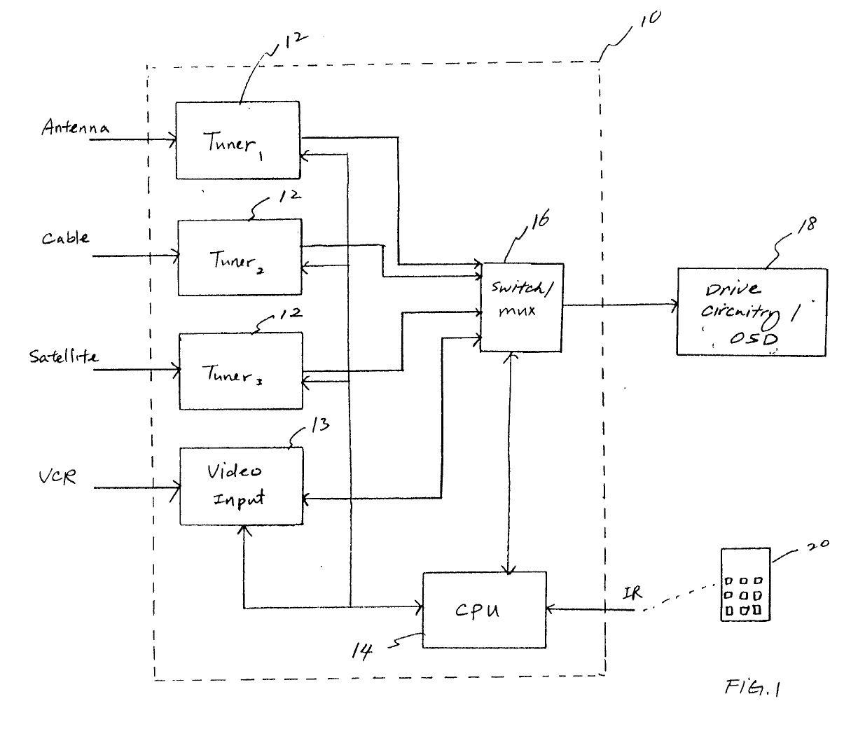

FIG. 1 is a functional block diagram of an apparatus 10 capable of providing a seamless transition between different channels/programs associated with different input signal sources in accordance with a first embodiment of the present invention. As shown in FIG. 1, the apparatus 10 includes a plurality of tuners 12; a central processing unit (CPU) 14; a switch/multiplexer circuitry 16; and, a driving circuitry/on screen display (OSD) 18.

In the embodiment of FIG. 1, broadcast signals received from an antenna, cable source, satellite, and VCR are coupled to the respective tuners 12 and the video input interface 13 of the apparatus 10. Although a limited number of input signal sources is shown in FIG. 1 for illustrative purpose, it is to be understood that the present invention is capable of receiving signals from a larger number of systems (i.e., telephone line, optical fiber, manual input median, recorded medium, etc.) or broadcast providers. Thus, the number of input signal sources in the drawing should not impose limitations on the scope of the invention. The function of an array of tuners 12 and the video input interface 13 is to demodulate and decode incoming channel signals, which include video and audio information, from various sources on the given system. The CPU 14 causes the switch circuitry 16 to couple one of these decoded channel signals to the driving circuitry 18 in response to a user input (i.e., a channel change request or surfing through various available channels). Thereafter, the output of the switch circuitry 16 is forwarded to the driver circuitry 60 for display. Those skilled in the art will readily understand that the driving circuitry/OSD 18 may be incorporated into the television set as a means to pump signals into the display screen using any one of a number of standard techniques.

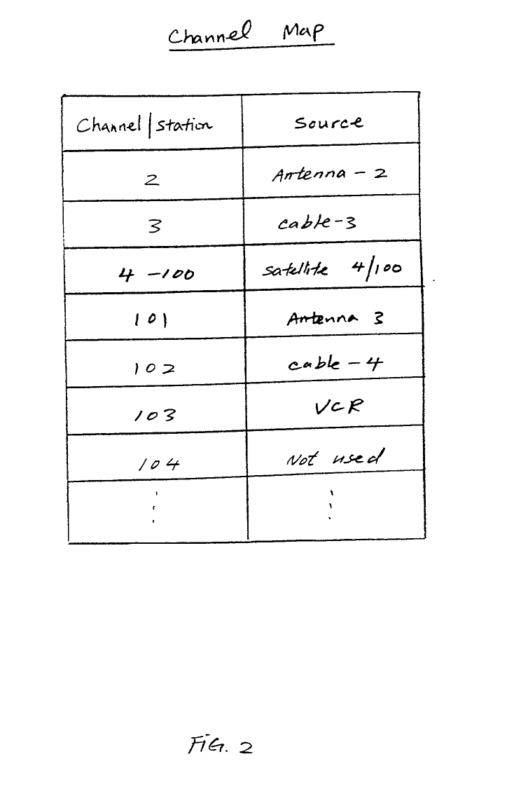

An infrared (IR) remote control device 20 is also provided to communicate with the CPU 14 to issue instructions selected by the viewer to the CPU 14. The remote control device 20 comprises conventional channel changing buttons in the form of a numeric keypad, a volume control button, and an up channel/down channel button. The illustrative channel map used for channel-changing operation is shown in FIG. 2, and described below.

FIG. 2 illustrates a predefined channel map information that is initially programmed by a viewer. Using the remote control device 20, viewer specifies an input source (i.e., antenna, cable, etc.) corresponding to the channel station number under the source column heading. For example, channel station 2 is specified to designate channel 2 from the antenna source. In this manner, each channel signals (i.e., different stations/programs) from multiple sources is selectively associated with a predefined identifiable channel station number. Alternatively, the incoming channels can be also assigned under different set of categories—i.e., adults, children, entertainment, education channels—or other predetermined criteria desired by the viewer. In the event that the viewer wishes to display a specific channel station associated with the channel map, the CPU 14 controls the output of the multiple tuners 12 and the switch circuitry 16 to decode and select the desired channel for display to the viewer. Hence, the viewer can simply press a channel number key or designated key, such as a page down key (i.e., scroll down key), for the desired channel program to be displayed. Furthermore, in the embodiment of the present invention, a viewer can request to display the channel map information, or if no channel map information is available, the viewer is notified of this fact via a display screen (not shown).

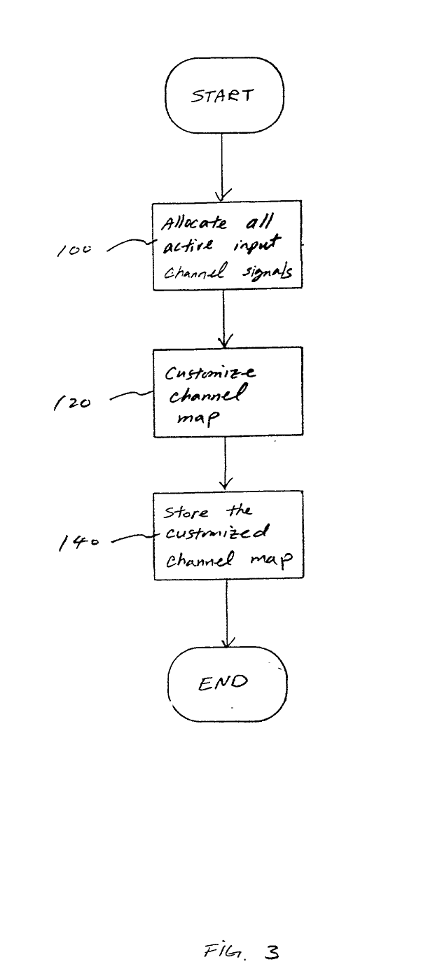

FIG. 3 is a flow chart illustrating the method of generating channel map information described above. Referring to FIG. 3, the initial set-up of creating channel map may be initiated by an auto set-up routine which detects all active channel signals from various input signal sources in step 100. The result of the auto set-up routine may be interactively formatted by the viewer to associate the detected input channel signals to one of the channel station numbers he or she wishes, in step 120. To achieve this, instructions can be inputted directly by operating various keys on an IR remote control device 20 and/or a keyboard (not shown). Thereafter, the remote controller 20 will transmit channel assignment instruction signals to the CPU 14 to generate a channel map similar to FIG. 2.

In step 140, the newly formatted channel map is stored in a random access memory (RAM) (not shown). The RAM may be coupled to the CPU 14 or may be provided independently in a remote location.

Alternatively, a predefined channel map, similar to FIG. 2, may be also available in a removable memory medium, i.e., key cards or smart cards. As occasion demands, the predefined channel map can be retrieved from the removable memory medium, which is typically used in conjunction with the television set or set-top box.

For example, these removable predefined channel maps may be provided by local or national content/service providers. In addition, the removable predefined channel maps may be organized in a variety of ways: (1) channels organized based upon different categories such as family channels, new channels, etc., (2) channels may be available based upon different times of the day (“G” rated during the day and “R” rated at night), or (3) channels may also organized based upon the content/service provider.

Illustratively, in the example numbered (3) above, each content/service provider may provide a removable predefined channel map for the channels/programs offered to a subscriber. During the channel map step up phase discussed above, multiple removable predefined channel maps may be read to create of the over-all viewer channel map.

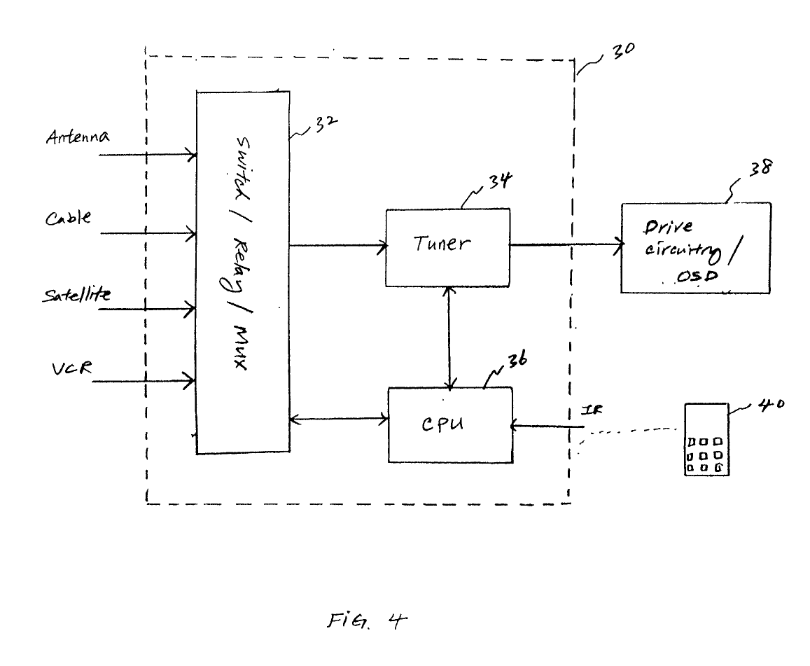

FIG. 4 illustrates a simplified functional diagram capable of switching a channel among a plurality of sources selected by a viewer in accordance with a second embodiment of the present invention. Major components of the apparatus 30 include a switch/relay/multiplexer 32, a tuner 34, a control processor 36, and a drive circuitry/OSD 38. In this embodiment, the CPU 36 controls the overall operation of the switch/relay/multiplexer 32 and the tuner 34. Under the control of the CPU 36, the output of the switch/relay/multiplexer 32 selected by a user is forwarded to the tuners 34 to be demodulated and decoded, and the decoded information is forwarded to the driver circuit/OSD 38. The output of the tuner 56 is fed to the driver circuitry 60 for display. The apparatus 50 is also provided with an infrared (IR) remote control device 40 to communicate with the CPU 36 to issue instruction to the CPU 14. Hence, the construction and operation of the second embodiment are essentially the same as that described above with respect to FIG. 1. The only notable difference is that a single switch/relay/mux 32 is provided to selectively retrieve the desired channel program in response to a user's request. Then the selected program is forwarded to the tuner 34 to be decoded and displayed.

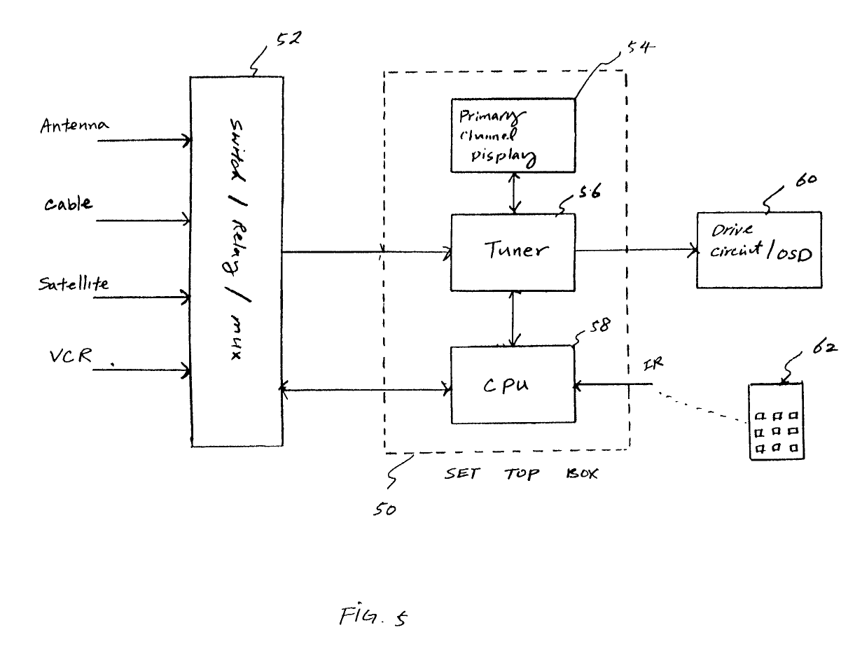

FIG. 5 illustrates a third embodiment of the present invention in which a set-top box 50 is utilized to implement the invention. As shown in FIG. 5, the set-top box 50 is arranged similar to the second embodiment. The set-top box 50 receives television broadcast from a switch/relay/mux 52 and feeds the broadcast signals to a television set (not shown) for display. The switch/relay/mux 52 is coupled to receive different input signals directly from a satellite feed and other source feeds, including antenna, cable, VCR, etc. The set-top box 50 also includes a primary channel display 54; a tuner 56 for decoding incoming signals; a CPU 58 for controlling the overall operation of the set-top box 50; a driver circuit/OSD 60 for displaying images on the television screen. A remote control device 62 is provided to issue channel-changing instructions to the CPU 58.

In general, a TV network has a primary channel that a viewer tunes into to watch the TV program/show. The viewer tunes to the primary channel using the channel changing buttons in the remote control device 62. As the broadcast signals from a primary channel are received by the set-top box 50, the primary channel number display 54 displays the primary channel number to the viewer. In the third embodiment, one input is designated as the primary source (i.e., the satellite feed) and the remaining channel signals from other input feeds (i.e., antenna, cable, VCR, etc.) are added after the last available channel used by the primary channel, thus generating a channel map similar to FIG. 2.

The construction and operation of the second embodiment are essentially the same as that described above with respect to FIG. 4, except that the set-top box 50 further includes a primary channel display 54 for showing the primary channel number, i.e., “4”. Accordingly, the discussion of similar components described in the preceding paragraphs is omitted to avoid redundancy, as they are described with respect to FIG. 4.

In operation mode, if the transmitted signal from the remote control 63 involves channel-changing information, the number of the selected primary channel is displayed on the primary channel display 54. If the transmitted signal involves other control signals such as a volume control or TV operating settings, the CPU 58 informs the appropriate control circuits (not shown) of the set-top box 50 to operate. Under the control of CPU 58, the switch/relay/mux 52 is coupled to receive one of the incoming transmission signals desired by the viewer and feeds it to the tuner 56, which in turn is forwarded to a driver circuit 60 for display on the television set.

It is apparent from the foregoing that the method and apparatus according to the present invention provide several important advantages in that the invention allows the viewer to readily switch a desired program without the need for manually switching between different channels/TV programs associated with different input signal feeds. Therefore, the viewer simply tunes to a single station, and then changes the channel as desired without the inconvenience of having to manually switch the input feed, which is often too slow for the pace of the event.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention includes all embodiments falling within the scope of the appended claims.

What is claimed is:

1. An apparatus for providing a program selected by a viewer from a plurality of sources, comprising:
a plurality of tuners coupled to receive incoming channel signals from the plurality of said sources, said tuners being operative for decoding said received channel signals;
a switch circuit coupled to receive the output signals from each of said tuners; and,
a controller coupled to said tuners and said switch circuit, said controller being operative for retrieving output signals representing the program selected by said viewer according to a predetermined channel map information.

2. The apparatus of claim 1, further comprising a driving circuit for coupling the output signals of said switch circuit to a television set for display.

3. The apparatus of claim 1, further comprising a storage means coupled to said controller for storing said predetermined channel map information.

4. The apparatus of claim 1, further comprising an input means for transmitting a viewer's request to said controller.

5. The apparatus of claim 1, wherein said channel map information comprises a list of channel station numbers associated with the plurality of said sources.

6. The apparatus of claim 1, wherein said controller associates with the plurality of said sources according to a numeric order.

7. The apparatus of claim 1, wherein said tuners receive said incoming channel signals from the group consisting of cable, antenna, satellite, telephone line, optical fiber, manual input median, and recorded medium.

8. A method for providing a desired television program among a plurality of sources to a television system, the method comprising the steps of:
receiving a plurality of television programs from the plurality of said sources;
transmitting a request to switch from one television program to another television program selected by a viewer;
retrieving one of the television programs selected by said viewer from the plurality of sources according to a predetermined channel map information; and,
forwarding said retrieved television program to said television system for display.

9. The method of claim 8, wherein said predetermined channel map information is prepared according the following steps:
scanning active input channel signals from the plurality of said sources;
interactively formatting said channel map information according to predetermined criteria; and,
storing said formatted channel map in a memory.

10. The method of claim 8, wherein said predetermined channel map information comprises a list of channel numbers corresponding to the plurality of said sources.

11. The method of claim 8, wherein the receiving step receives said television programs from the group consisting of cable, antenna, satellite, telephone line, optical fiber, manual input median, and recorded medium.

12. An apparatus for providing a program selected by a viewer among a plurality of different program sources to a television system, comprising:
a switch circuit having a plurality of input ports and an output port switchably coupled to receive incoming channel signals from the plurality of sources;
at least one tuner coupled to receive the output signals from said switch circuit, said tuner being operative for decoding the output signals from said switch circuit; and,
a controller coupled to said switch circuit and said tuner for coupling the output signals indicative of the program selected by said viewer from said switch circuit to said tuner.

13. The apparatus of claim 12, further comprising a driving circuit for displaying the output signals of said tuner to said television set.

14. The apparatus of claim 12, further comprising an input means for transmitting a viewer's request to said controller according to a predetermined channel map information.

15. The apparatus of claim 14, wherein said channel map information includes at least one channel number on which each program is to be displayed.

16. The apparatus of claim 14, further comprising a storage means in communication with said controller for storing said predetermined channel map information.

17. The apparatus of claim 12, further comprising a display unit for displaying a channel station number of the problem selected by said viewer.

18. The apparatus of claim 12, wherein said switch circuit receives said incoming channel signals from the group consisting of cable, antenna, satellite, telephone line, optical fiber, manual input median, and recorded medium.

19. A method of switching a channel among a plurality of different program sources according to a predetermined channel map, said channel map includes a list of channel numbers corresponding to the plurality of said sources, the method comprising the steps of:
enabling a user to designate a desired channel for viewing based on said predetermined channel map via user input means;
generating a channel-changing signal to a television set in response to the activation of a channel button on said input means;
switching, in response to said user, from a first channel to a second channel, which corresponds to said desired channel;
decoding output signals from said second channel; and,
forwarding said decoded signals to said television system for display.

20. The method of claim 19, further comprising the step of formatting said predetermined channel map information according the following steps:
scanning active input channel signals from the plurality of said sources;
interactively formatting said channel map information according to a user-defined ordering scheme; and,
storing said formatted channel map in a memory.
